(19) United States
(12) Patent Application Publication
(10) Pub. No.: US 2002/0091687 A1
(43) Pub. Date: Jul. 11, 2002

(54) Decision support system

(76) Inventor: Thor Eglington, Ottawa (CA)

Correspondence Address: Shapiro Cohen, Station D, P.O. Box 3440, Ottawa, K1P 6P1, CA

(21) Appl. No.: 09/951,448

(22) Filed: Sep. 14, 2001

Related U.S. Application Data
(60) Provisional application No. 60/236,156, filed on Sep. 29, 2000.

(51) Int. Cl. G06F 7/00

(52) U.S. Cl. 707/5

(57) ABSTRACT

A medical information decision support system is provided, the decision support system including a decision triad. The decision triad includes an information/directives repository operatively connected to an adaptive chart and a decision module via a decision generator wherein the decision generator determines options for providing medical service to a patient based on information from the information/directives repository, the adaptive chart and input from a user.

### FIELD OF THE INVENTION

The present invention relates to a medical diagnostic support system having interactive communication between the physician and the system. A medical information decision support system is provided, the decision support system including a decision triad. The decision triad includes an information/directives repository operatively connected to an adaptive chart and a decision module via a decision generator wherein the decision generator determines options for providing medical service to a patient based on information from the information/directives repository, the adaptive chart and input from a user.

### BACKGROUND OF THE INVENTION

In the past five years, information technology (IT) using the Internet has enabled many industries to increase their business efficiencies and effectiveness through unfettered access to the different forms of information they require. This access has most changed the work methods of industries requiring immediate, confidential access to evolving information, with the exception of the practice of Medicine, as documented by P. Szolovits' “A Revolution in Electronic Medical Record Systems via the World Wide Web.” MIT Laboratory for Computer Science 2000, and by M. Herrick & A. Patterson's “Healthcare Trends—The Big Picture Megatrends You Need To Know.” Journal of AHIMA 2000.

Medical practices are bound by particular irrational and concrete information dissemination problems. These dissemination problems substantially diminish the impact IT could have in resolving inefficiencies—in particular inefficiencies related to: keeping medical practices abreast of new developments in medical knowledge, and accounting for all relevant information in treating a patient, as disclosed by Herrick & Patterson, supra. These problems are particularly acute for paper- or computer-based clinical Decision Support Systems (DSS).

Table 1, below, lists concerns that physicians and medical practitioners have had concerning the use of decision support systems in the clinical setting, as disclosed by T. Eglington's “Barriers to Implementing Clinical Practice Guidelines & Recommendations for Action to Be Taken by the WHC to Reinforce the Implementation of Clinical Practice Guidelines in Ontario.” Women's Health Council of Ontario 2000. In particular, these concerns include: 1) a physicians' concern over bias (e.g., pharmaceutical/HMO), 2) exploitive, commercial use of intelligence generated by mining, scrubbing and analysing data gathered in the course of system use, and 3) disbelief that the system has up-to-date validity. Medical practices outside of hospital-like institutions (i.e., “tertiary” settings) have the most difficulty with DSSs.

At present, the methods physicians use to keep their practices abreast of new information are labour intensive, often requiring seminar attendance and/or multi-day study sessions. These requirements often diminish participation with the result that physicians' practices may fall behind with respect to newly discovered medical knowledge. For example, it is estimated the average general practitioner's practice is several months behind the relevant information.

As a result, software tools and Internet portals to help physicians keep abreast of recent developments have been developed. However, at present, these tools and portals have a number of deficiencies.

TABLE 1
Medical Practitioner Decision Support System (DSS) Concerns

| Concern DSS advisories will become a standard, as opposed to representing | |
|---|---|
| an existing or accepted standard. | |
| | Threat to practice autonomy. |
| | MD health beliefs may be at odds with DSS advisories. |
| MDs unconvinced of gains from using evidence-based DSS advisories as | |
| opposed to guidance from human mentors. | |
| | MDs often not aware of overall benefits of the latest research |
| | incorporated into DSS advisories. |
| | DSS advisories can become obsolete rapidly, diminishing benefit of |
| | learning them. |
| Conflicting objectives of DSS developers. | |
| | MDs are concerned about potential biases in DSSs. |
| | Existing practice incentives often do not address the additional effort |
| | required to incorporate DSS advisories into practice. |
| Ongoing overload of medical information for MDs to learn is exacerbated by | |
| need to also learn to use a DSS. | |
| Inability of licencing bodies to monitor implementation of DSSs, in order to | |
| accredit the use of DSS advisories and provide DSS accreditation. | |
| | Problematic to efficiently monitor DSS compliance across multiple |
| | settings. |
| DSSs generally generic because of the need to be universally applicable, but | |
| are thereby impractical when dealing with the idiosyncratic nature of illness. | |
| | MDs have sense that DSSs will never be complex enough to |
| | accommodate all possible clinical variations. |
| Public's perspective and their intangible needs often ignored in DSSs. | |
| | Patients' treatment wishes may be at odds with DSS Advisories. |

MDs often unable to subjectively evaluate their need for practice guidance.
MDs generally late-starters in using information technology.

That is, many software tools and Internet portals used by physicians to stay abreast: require labourious searches to extract the relevant information from thousands of recent publications, which must be undertaken periodically to remain up-to-date—this can diminish the frequency and effectiveness of attempts to remain abreast; require the physician to search literature by coded key words, often not directly related to in-situ practice—this can lead to missed information as a result of poor coding or the physician's limited knowledge of appropriate key words; do not state how the information is relevant to ongoing practice, forcing the physician to expend effort translating information into practice, and providing an opportunity for misinterpretation—this can diminish the frequency and effectiveness of attempts to remain abreast, and can lead to sub-optimal practice; do not state how the information is relevant to all aspects of care (diagnosis, education, prevention, treatment, and rehabilitation)—this can lead to haphazard, inconsistent use of information in practice and sub-optimal continuity of care, and thereby sub-optimal clinical outcomes; do not incorporate newly released information into practice advisories systematically—this can lead to haphazard, inconsistent use of new information in practice; and, do not integrate the physician's clinical opinion or in-situ knowledge with the electronic information without undermining this information—this can reduce the acceptance and use of automated DSSs.

Furthermore, there are significant problems for medical practitioners in keeping charting methods abreast of new practices. In modern clinical practice, substantial weight is placed on tracking all aspects of the physician-patient interaction and, accordingly, computer-based charting tools using templates have been developed to reduce the effort of charting. However, at present, most templates are not optimally efficient in that they: do not tailor themselves parsimoniously to the patient's particular situation—this can lead to the collection of superfluous data; do not remind the physician of data to be collected—this can result in missed data; do not enable a real-time amalgamation of historical data with new data—this can lead to missed observations; do not automatically evolve as the types of charted data and related practice decisions evolve—this can lead to situations where the data necessary to carry out a novel practice, or data substantiating a novel clinical decision are not collected and recorded; and, do not support in real-time the ongoing revitalization of what is considered best practice by the medical community—this can lead to sub-optimal practice without the physician being aware of this at the point-of-care.

Accordingly, there is a need for a medical information decision support system which overcomes the inefficiencies noted above and, in particular: increases the efficiency and effectiveness of delivered care, reduces the frequency/severity of medical errors, increases a users' satisfaction in practice, increases patients' satisfaction in being treated, and appropriately defers liability from health practitioners to the medical evidence-base.

In addition, the use of such a medical information decision support system can lead to significant financial savings among various groups, including among others: malpractice insurers, private health insurers, public health insurers, private health-provider organizations, and pharmaceutical cost-control organizations.

A review of the prior art reveals that such a system, which also dynamically links information between a decision tree, medical chart and information/directives repository, has not been developed.

For example, U.S. Pat. No. 6,029,138 (issued Feb. 22, 2000) discloses a computer system for decision support in diagnostic and therapeutic tasks which uses data extracted from existing scientific literature, U.S. Pat. No. 5,953,704 (issued Sep. 14, 1999) discloses a health care management system for comparing user-proposed and recommended resources required for treatment, U.S. Pat. No. 6,047,259 (issued Apr. 4, 2000) discloses a system including interactive software tools for conducting a physical exam, suggesting tentative diagnoses and managing a treatment protocol, U.S. Pat. No. 5,594,638 (issued Jan. 14, 1997) discloses a computerized medical diagnosis system which is primarily used over a telephone network, U.S. Pat. No. 5,867,821 (issued Feb. 2, 1999) discloses a system for accessing and distributing personal health care information, U.S. Pat. No. 5,924,074 (issued Jul. 13, 1999) discloses an electronic medical records system, U.S. Pat. No. 6,026,363 (issued Feb. 15, 2000) discloses a medical history documentation system and U.S. Pat. No. 6,018,713 (issued Jan. 25, 2000) discloses an integrated system for ordering medical tests and reporting the results.

### SUMMARY OF THE INVENTION

In accordance with the invention, a medical information decision support system is provided, comprising a decision triad, the decision triad including an information/directives repository operatively connected to an adaptive chart and a decision module via a decision generator wherein the decision generator determines options for providing service to a patient based on information from the information/directives repository, the adaptive chart and input from a user. In a specific embodiment, the decision module displays weighted choices (WC) and recommended advisories (RA) in response to user input and each weighted choice includes a computed weight of the probability of accuracy of the weighted choice presented and the computed weight is determined by the decision generator from current data from the adaptive chart and information/directives repository.

In another aspect, the selection of a weighted choice or recommended advisory by a user displays further weighted choices or recommended advisories determined by the decision generator from current data from the adaptive chart and information/directives repository and/or each weighted choice and recommended advisory is linked to references and summaries of relevant information in the information/directives repository.

The system may further include an adaptive chart which is operatively connected to an electronic medical record (EMR), to a laboratory for data entry into the adaptive chart and/or to an uploading module for uploading information to the information/directives repository.

Still further, a recommended advisory (RA) may be dynamically linked to the adaptive chart module wherein user selection of an RA displays a data entry form on the adaptive chart.

In a more specific embodiment, the information/directives repository may include referenced, standardized summaries of medical information including any one of or a combination of policy and position statements, clinical practice guidelines and formulary statements and/or interpretational clinical directives including any one of or a combination of differential diagnosis trees, treatment algorithms, care-maps, and management protocols.

In another aspect, the adaptive chart may display trends in clinical data based on current and historical patient data and computed by the decision generator.

In another aspect, user selection of a decision module option or entry of data into the adaptive chart provides an update of the information displayed in the information/directives repository, the adaptive chart or the decision module.

In yet a further aspect, a system for supporting decision-making is provided comprising a general information database operatively connected to a situation-specific database and a decision tree through a decision generator, the decision generator for determining decision options for presentation to a user through application of situation-specific database rules to general information governed in itself by general database rules.

In another aspect, the decision generator provides instructions to a tree rendering engine for displaying a limited number of decision options to the user, the decision generator provides instructions to a chart engine to display relevant data from the situation-specific database and for user-entry of data into the situation-specific database and/or the decision generator provides instructions to a general information database engine to display information relevant to a specific situation from the general information database.

In a further aspect, the invention provides an interface for displaying information for assisting a user in a decision-making process comprising a concurrent display of a decision tree, a general information database and a situation-specific database wherein the decision tree display presents options to a user which upon selection of a specific option updates the general information database display and situation-specific database display to display information relevant to the selected option.

In yet a further aspect, the invention provides a method of assisting a user in a decision-making process comprising the steps of concurrently displaying a portion of a decision tree, a general information database and a situation-specific database wherein the decision tree display presents options to a user which upon selection of a specific option updates the general information database display and situation-specific database display to display information relevant to the selected option only.

### BRIEF DESCRIPTION OF THE DRAWINGS

These and other features of the invention will be more apparent from the following description in which reference is made to the appended drawings wherein:

FIG. 1 is a block diagram of a decision support system in accordance with the invention;

FIG. 2 is a block diagram of the network distribution of the decision support system of an embodiment of the invention;

FIG. 3 is a block diagram of the underlying system engines of the decision support system in an embodiment of the invention;

FIG. 4 is a block diagram of a user's entry into the decision support system in accordance with an embodiment of the invention;

FIG. 5 is a block diagram illustrating various actions of the decision generator and decision support system modules subsequent to user entry, initiating diagnosis in accordance with the invention;

FIG. 6 is the display of the information supplied by the decision support system to the physician as a result of initiating diagnosis of a patient, as per FIG. 5;

FIG. 7 is a block diagram illustrating various actions of the decision generator and decision support system modules during diagnosis, while advising procedures and receiving information from the physician;

FIG. 8 is the display of the information supplied by the decision support system to the physician as a result of the decision generated as per FIG. 7;

FIG. 9 is a block diagram illustrating various actions of the decision generator and decision support system modules during diagnosis, after the previous action called for in FIG. 7, while advising procedures and receiving information from the physician;

FIG. 10 is the display of the information supplied by the decision support system to the physician as a result of the decision generated as per FIG. 9;

FIG. 11 is a block diagram illustrating various actions of the decision generator and decision support system modules during diagnosis, after the previous action called for in FIG. 9, providing Weighted Choices (WC) to the physician;

FIG. 12 is the display of the WCs and odds ratios (OR) generated by the decision support system as a result of the decision generated as per FIG. 11;

FIG. 13 is a block diagram illustrating various actions of the decision generator and decision support system modules initiating treatment in accordance with the invention, after the previous action called for in FIG. 11, while advising procedures and receiving information from the physician;

FIG. 14 is the display of the information supplied by the decision support system to the physician as a result of initiating treatment of a patient, as per FIG. 13;

FIG. 15 is a block diagram illustrating various actions of the decision generator and decision support system modules during treatment, after the previous action called for in FIG. 13, providing Weighted Choices (WC) of treatment alternatives to the physician;

FIG. 16 is the display of the WCs and odds ratios (OR) generated by the decision support system as a result of the decision generated as per FIG. 15;

FIG. 17 is a block diagram illustrating an example of actions of the decision generator and information/directives repository during treatment, after the previous action called for in FIG. 16, providing clarification of an odds ratio;

FIG. 18 is the display of the clarification and elaboration of the odds ratios of alternative treatments generated by the decision support system as a result of the decision generated as per FIG. 17;

FIG. 19 is a block diagram illustrating further actions of the decision generator and decision support system modules during treatment in accordance with the invention, after the previous action called for in FIG. 17, while advising procedures and receiving information from the physician;

FIG. 20 is the display of the decision support system requesting chart data, as a result of the decision generated as per FIG. 19

FIG. 21 is a block diagram illustrating continued actions of the decision generator and decision support system modules during treatment in accordance with the invention, advising procedures and requesting chart data, after the previous action called for in FIG. 19, while advising procedures and receiving information from the physician; and

FIG. 22 is an example of a display of the decision support system during diagnosis/treatment indicating the necessity for further treatment.

### DETAILED DESCRIPTION OF THE INVENTION

### System Overview

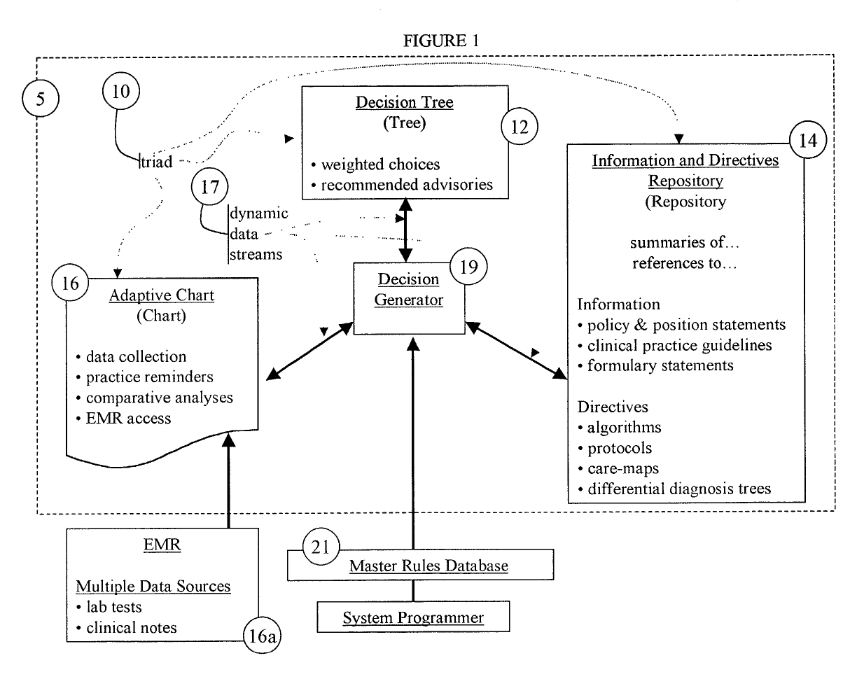

With reference to FIGS. 1-3, a medical information decision support system 5 is shown. The system includes a triad 10 of modules 12, 14, and 16 which interact with decision generator 19 to provide a computer-based medical decision support system (DSS) for a user.

The system provides a solution to the specific problem of translating medical information or clinical directives into patient-specific practice advisories, at the point-of-care, in real-time. Its structure and operation resolve many of today's DSSs' weaknesses described above.

The triad can assist in clinical decisions over local or wide-area networks either on its own or in conjunction with other specialized clinical information modules, to aid in the clinical management of patients.

The triad 10 is made up of three primary modules (FIG. 1) including a decision tree 12 (tree), an information/directives repository (repository) 14, and an adaptive chart page (chart) 16. The three modules are electronically interlinked by dynamic direct data streams (DDS) 17 under the control of a decision generator 19 and a master rules database 21, through the hub-like decision generator 19.

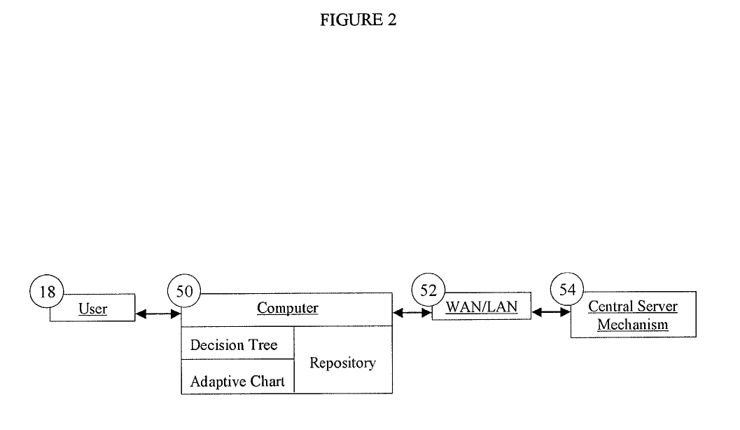

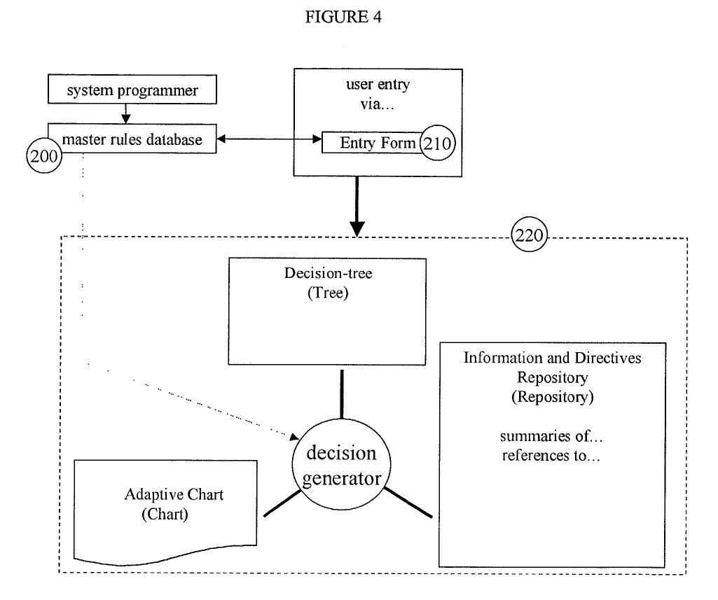

For clinical problem solving, the triad 220 (FIG. 4) is accessed in accordance with limits delineated by the master rules database 200 by a physician (“user”) through a secure entry point (entry form 210). The user 18 (FIG. 2) entry hardware may be a computer 50 with user ID/password requirements operatively connected to a wide and/or local area network 52 and a central server mechanism. Upon entry into system, the user is directed to, or chooses to link to the system's 5 (FIG. 1) modules as necessary.

Generally, among the modules, the tree 12 allows a user to view weighted or unweighted practice advisories, the information/directives repository 14 displays information or research references related to these advisories, and the chart 16 provides data collection and display tools which can act as practice reminders and perform comparative analyses using clinical data from an electronic medical record (EMR) 16a. At any time, if appropriate, one of the three modules 12, 14 or 16 provides information to the other two modules. In this way, the triad 10 remains an evolving tool amalgamating sources of information for the user 18 (FIG. 2) through the dynamic data streams (DDS) 17 (FIG. 1).

The triad 10 has a number of roles relating to the collection and distribution of information. As a support for clinical problem solving and decision making, the triad 10 guides a user's diagnosis, education, prevention, treatment, or rehabilitation activities involved in providing medical care. Furthermore, as a knowledge synthesizer, the triad 10 automatically links, in real-time, clinical choices and actions to medical information (including among others: policy and position statements, clinical practice guidelines, formulary statements), clinical directives (such as: differential diagnosis trees, treatment algorithms, care-maps, management protocols), a patient's medical history, and ongoing medical decisions.

The triad 10 is also evolutionary in that the triad is preferably in ongoing renewal as raw medical information is introduced into the decision generator 19. That is, as new medical knowledge is uploaded and programmed into the system, each of the triad's modules adapts itself to the evolving clinical problem solving of a user, in real-time.

### Clinical Decision Triad: Details

The triad 10 is made up of three primary modules (FIG. 1) including a decision tree 12 (tree), an information/directives repository (repository) 14, and an adaptive chart page (chart) 16. The three modules are under the control of the decision generator 19 and master rules 21. The three are electronically interlinked by dynamic direct data streams (DDS) 17 through the hub-like decision generator.

Decision Tree (Tree)

In a preferred embodiment, the tree 12 graphically displays decision points that may be selected by a user to direct the user's understanding, diagnosis, education, prevention, treatment, or rehabilitation of a patient. Principally, the tree displays these decision points to the user as options including “Weighted Choices” (WC) or “Recommended Advisories” (RA). Each decision point may present options leading to one or more sequenced WCs or RAs.'

At a decision point, users, either complete or override (skip) decision points, to be presented with the next best-evidenced WC or RA. Completing a series of WCs/RAs guides a user through part or all aspects of caring for a patient, (e.g., treatment).

The tree 12 may be tailored to clinical practice in specific settings depending on the user. For example, decision branches can be tailored to the needs and practice realities of rural or urban settings, or to underlying protocols of primary, secondary or tertiary institutions.

Weighted choices (WC).

Generally, a WC is information displayed to a user relating to a set of conditions, with a computed weight as to the relative probability the information is absolutely correct. For example, different WCs may suggest different treatments with a relative weight applied to each treatment. The WC weight is determined in real-time by the decision generator's computational processes, which apply heuristic and numeric programming algorithms to the available medical information (including among others: policy and position statements, clinical practice guidelines and formulary statements), clinical directives (including; differential diagnosis trees, treatment algorithms, care-maps, and management protocols), and clinical patient data (from the electronic medical record [EMR] 16a or data directly input into the system). WCs are dynamically linked to references and summaries of the relevant research in the repository 14.

Recommended advisories (RA).

RAs differ from WCs insofar as they are not weighted. RA's represent the best-evidenced action to be taken or a point of information, that considers all other information available to the triad. In general, RAs are descriptions of activities to be undertaken (e.g., collect vital signs, ask history questions). RAs are dynamically linked to references and summaries of the relevant research in the repository 14.

Information/directives Repository (Repository)

The repository 14 holds referenced, standardized summaries of medical information (including policy and position statements, clinical practice guidelines and formulary statements) and interpretational clinical directives (including: differential diagnosis trees, treatment algorithms, care-maps, and management protocols) that are most relevant to medical practice. At any given time during use, the repository will preferably display summaries that reflect the WC or RA the user has reached in following the tree path.

The original, summarized information and directives may be those available in the public domain (e.g., scientific journals) and reflect the original information used to substantiate the WCs or RAs. The summaries include all the information necessary to manage information-flow (e.g.: evidence quality ranking of the original information following scientifically accepted rating schemes [for example, Canadian Task Force evidence grades]; original piece's reference [in standard scientific format]; date of modifications, and identity and purpose of personnel modifying the information).

Preferably, and should the user wish to, information-flow qualifiers will allow the user to judge whether the WC or RA is up-to-date. That is, and in accordance with a preferred practice, it is desirable that the inclusion of new research is uploaded promptly into the system, for example within three weeks of publication.

Adaptive Chart (Chart)

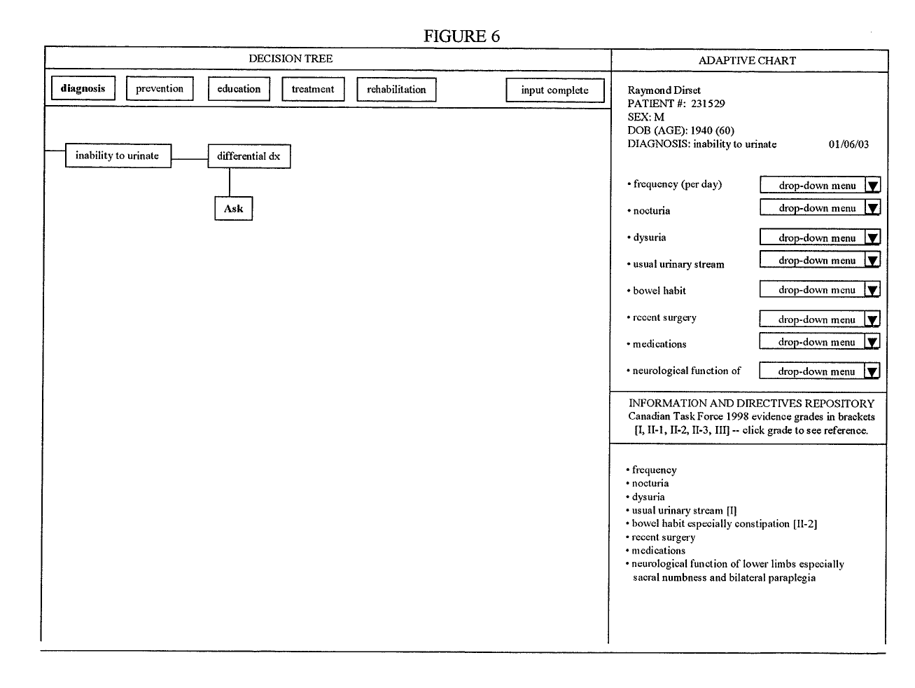

The chart as illustrated for example in FIG. 6, is an interface that is specifically updated to a particular WC or RA that the user has reached in the tree 12. The chart displays information specifically related to the patient's condition and may specifically display patient data that should be gathered to be able to complete the presented WC or RA, for the user to ultimately make a decision about the care offered to the patient. Data entered into the chart is automatically and dynamically linked to relevant items in the tree 12 and repository 14.

In another aspect, the chart is also capable of analysing and uncovering trends in clinical data that are relevant to the ongoing care of the patient. This is achieved by importing a patient's existing electronic medical record (EMR) into the system, if available. Linking to historical patient data is prompted by the chart when this is clinically desirable, or may be undertaken on the opinion of the user without system prompting. When linked, the chart can highlight issues of concern and important trends in the patient's health, and ultimately, define the WCs and RAs that are displayed by the tree 12.

Direct Data Streams (DDS) & Decision Generator

The dynamic linking between the point reached by the user in any of the three modules and all other relevant information used to decide on a diagnostic, education, prevention, treatment, or rehabilitation activity uses a DDS system 17. The DDSs ensure that the decision generator 19 can compute input and output data so that the displayed data in whichever module is being accessed predicates the data displayed in the other modules throughout a user's clinical problem solving and decision making. For example, the user may leave the tree at one point, to access a repository summary or input data to the chart, and thereby be returned to the tree at another point, this latter point being determined by the summary disclosed or the data input to the chart.

These dynamic, bidirectional electronic links between each of the modules (and any combination thereof) operate at the internal speed of the computer on which the DDSs reside, with the results of their interaction (changing display of modules on a user's screen) operating at the speed of the network connecting the computers involved in using the system (local communications speed or wide-area communications [e.g., Internet] speed).

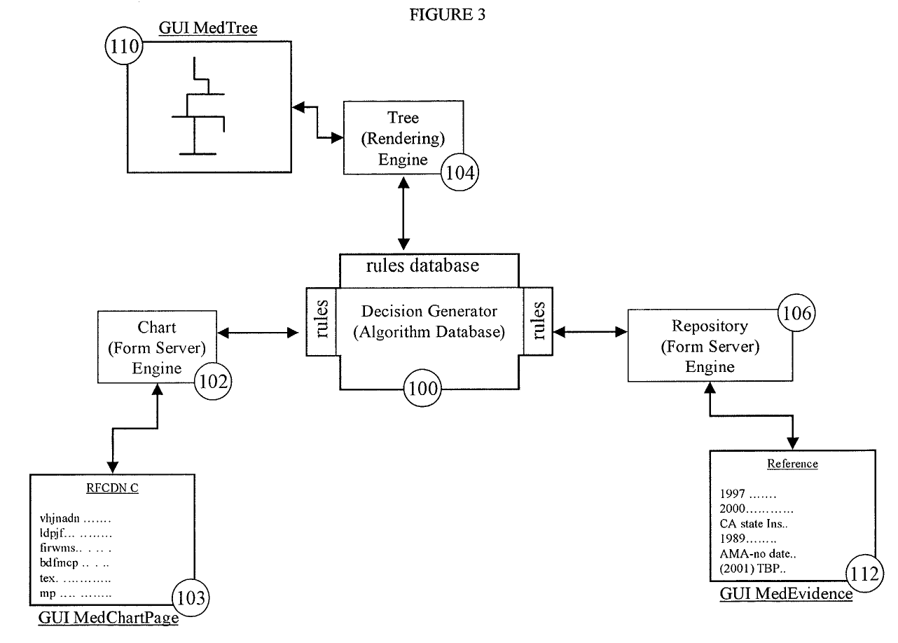

The decision generator 100 (FIG. 3) is software programming that operates at the internal speed of the computer on which it resides. The computations of the decision generator are subject to a master set of rules 21 that serve as an interface between a programmer and the system 5.

Using the system may include accessing the triad via an Internet connection, with digital or analog transducers. The triad is preferably designed to perform across the Internet with a communication bandwidth 2-fold less than that provided for video transfer, to ensure the triad will operate well with a maximum number of Internet service providers' infrastructures.

### Technology

In accordance with the invention, it is understood that the system as functionally described herein may be implemented using different technology models.

In a preferred aspect, the triad operates behind a Private-Public Keypair (PKI) firewall involving an independent certificate authority. All transactions outside the firewall (on the Internet or user's computer) are encrypted using Secure Sockets Layer (SSL) 128-bit encryption in concert with the PKIs. This verifies the identity of users and ensures the security of transmitted and stored data, users access the triad dialogues using their computer, web browser software, and client PKI software.

The efficiency of maintaining the triad is increased by using relational database software requiring minimum programming code development, and relying on original equipment manufacturer (OEM) support. For universality of input (e.g., images, text, direct data stream objects), the software used is preferably platform and file-format independent to enable a software-enhanced workflow.

The triad uses four technologic elements, shown in FIG. 3 as overlaying the triad's conceptual structure. The technologic elements include: 1) a decision generator 100 with integrated and module-specific (tree, chart, repository) rules databases, 2) direct data streams (DDS), 3) module-specific server-based engines 102, 104 and 106, and 4) module-specific graphical user interfaces (GUI) 108, 110 and 112.

The roles of each of these elements and specific considerations follow.

Decision Generator

The core of the working triad is the decision generator software. Each module has an independent rules database integral to the decision generator, that instructs its respective server-based engine and GUI, to produce one of the triad's three conceptual modules (tree, chart, repository).

The decision generator 100 handles all computational processes to generate decisions. Each decision is subject to rules so as to provide a command that is understood by a specific engine within each of the tree, chart and repository modules. The decision generator is subject to a master set of rules 21 that serve as an interface between a programmer and the system 5. The software is freestanding (decision object software), is ODBC, and is capable of weighted decision tree generation (e.g., Weighted Decision Object 1.0 [WDObj]—WDObj encapsulates the decision processing capability of Criterium DecisionPlus in an ActiveX object).

Dynamic Data Streams (DDS)

The DDSs 17 are the communications links responsible for the dynamic linking between the point reached by the user in either of the three modules and the information displayed in the other two. The DDSs ensure that each of the three module displays that is presented to the user shows information that is relevant to the other two module displays. The language used by the triad's DDSs is the contextually most effective of various standard computer communication protocols (e.g., HTTP, netBEUI, IPX/SPX). FIG. 1 conceptually illustrates the three triad DDSs.

Module-specific Server-based Engines (FIG. 3)

The tree 104, chart 102 and repository 106 engines are instructed by the decision generator's computational output so as to be able to create other instructions that inform each GUI what to display. In addition, as informed by a combination of the GUI state and data input via the GUI, the tree 104, chart 102 and repository engines 106 each distribute information to the decision generator.

Module-specific Graphical User Interfaces (FIG. 3)

The GUIs 108, 110 and 112 are a combination of the decision support system's programming and a user computer's software and hardware that exists independent of the decision support system described herein. The system's programming provides the module-specific rules necessary for the GUI to be able to interpret the commands originating in the engines 102, 104 and 106. The GUI's own programming provides a standardized software recipient (driver) that is able to transfer engine-originating commands on the user computer's display hardware in an understandable format. This standardized software recipient is openly available to enable the decision support system's programmers to compose code that allows the system to communicate freely with the GUI.

Information Storage

All data created by, or stored in the triad is in the form of documents (including text, images and objects of various functions) which are digitally stored in electrostatic, magnetic or optical media (computer chip-sets, computer tapes, cards or discs, CD-ROMs) in an indexed relational database (e.g., Microsoft Access).

Stored documents are indexed by key words and classified preferably by a formal, complementary classification system (identifies a document's unique software location and total number of applicable identifiers [e.g., Dublin Core Meta Information system]).

The storage software is able to extract web-sites and other linked digital information in an archival way (information content and context stored together). It captures in a standardized format (e.g., Adobe Portable Document Format [PDF]) various other formats of information directly or through transducer hardware: 1) linked Websites, 2) non-electronic (paper-based) information, and 3) most electronic formats used for information processing (e.g., word processors, desktop publishing).

The storage software preferably uses file-locking, audit trail, time stamping, and integrity checks to ensure the reliability and validity of stored information, and is secured by PKIs. It is preferably controlled with a comprehensive forms server (form structure is flexible, and transmits content and content-context as one, unique data-set) using appropriate mark-up language (e.g., XML).

Information Flow and Management

Documents are preferably formatted using forms that can track the work/information-flow of additions/deletions of, or modifications to documents. As such, the module displays themselves are preferably forms.

The operational capability of the DDSs to link the modules through the decision generator is reinforced by the generator's reciprocating comparison of form-queried information from each module. The generator continually initiates the chain of commands that re-tailors each display according to sets of rules that are integrated into the decision-generator itself.

Any one module form is therefore tailored by, and tailors the other two. This reciprocation is structured with software that creates returned-data-linked records (rule-base creates forms and guides the storage of the data collected using these forms), (e.g., PureEdge InternetForms Management Server). Once created, records are managed with the same database softwares used elsewhere in the system (e.g., Microsoft Access).

In being reciprocally compared, form-queried information is continually loaded into active computing memory, speeding computation. In this way, users changing the information shown for one module (i.e., changing that module form's content) will change the other module displays in real-time.

### EXAMPLE

An illustrative example of the operation of the system detailing a typical interaction between a user, the system and a patient is outlined in FIGS. 4-22. Within the example, the user has access to an Internet-enabled computer terminal for linking to the system's computer server mechanism as shown in FIG. 2.

The user interface preferably includes a three window graphical display of the tree, the chart and the repository.

### Step 1 (FIG. 4)

During a consultation, a patient complains of not being able to urinate and having a sore bladder. Through discussion, the user establishes that “inability to urinate” is a preliminary diagnosis and decides to use the system to ensure that subsequent practice decisions are up-to-date in dealing with a patient presenting these symptoms.

Initially, the user points his/her Internet web-browser to the system site and enters the site through an entry form that accepts his/her ID/password, preliminary diagnosis, and keywords indicating the way the user wishes to use the system. The user's point of entry into the system triad is determined through a combination of the users's knowledge of the condition and the patient's presenting complaint.

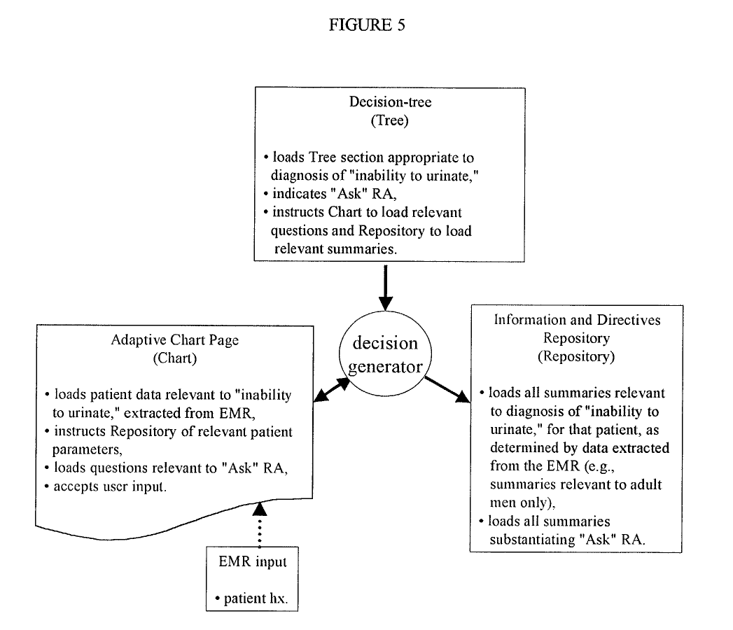

### Step 2 (FIGS. 5 and 6)

In this example, the physician's point of entry is determined by an a-priori understanding that “inability to urinate” is an accurate, but general diagnosis that requires confirmation.

As a result, the user enters the triad at a diagnosis confirmation level, the word diagnosis is shown in bold on FIG. 6. In this example, at the specific entry point, the system instructs the user to refine the initial diagnosis through differential diagnosis, by completing the first recommended advisory (RA) shown as “Ask” , and the questions to ask are enumerated in the adaptive chart window of the screen. The RA requests that the physician enter information into the chart. Preferably, the user may choose to continue without respecting the triad's RA, or may complete the first RA (“Ask”) as prompted.

The user asks the questions suggested by the chart, and enters the appropriate findings into the chart. Once completed, the user indicates to the system the RA “Ask” is complete.

System Operations and Displays

Tree.

Initially, the system loads the tree section appropriate to diagnosis of “inability to urinate,” and displays an RA decision point “Ask” which is a prompt indicating that user input about the patient is required.

The tree window displays the first branch and the decision path advising the user.

Chart.

As a result of the tree's decision point, the chart loads patient data relevant to “inability to urinate,” extracted from this patient's electronic medical record (EMR) if available. Minimum information relevant to the opening tree position, gathered from patient's history, is displayed such as patient name, age, and file ID.

Also, as a result of the tree's decision point, the chart displays questions relevant to the “Ask” RA. A formatted data entry page is displayed allowing entry of data specific to the RA “Ask.” For example, the user may be prompted to enter urinary frequency, nocturia, dysuria, usual urinary stream, bowel habit, recent surgery, medications and/or neurological function.

The chart accepts user input.

Repository.

As a result of the tree's decision point and the chart's display of questions relevant to the “Ask” RA, the repository loads all evidence summaries relevant to the diagnosis of “inability to urinate,” for that patient (as determined by data extracted from the EMR) and to the specific questions being asked. For example, summaries relevant to adult men of 60 years of age and specific to urinary frequency, nocturia, dysuria, usual urinary stream, bowel habit, recent surgery, medications and/or neurological function may be displayed, for this patient.

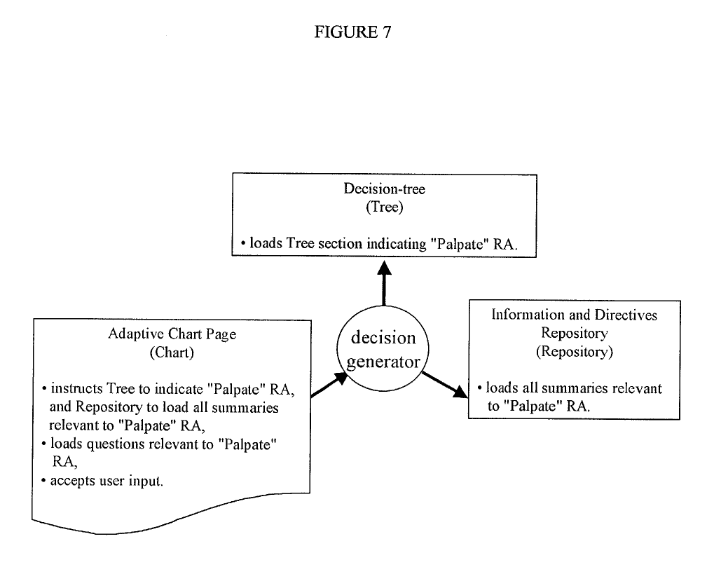

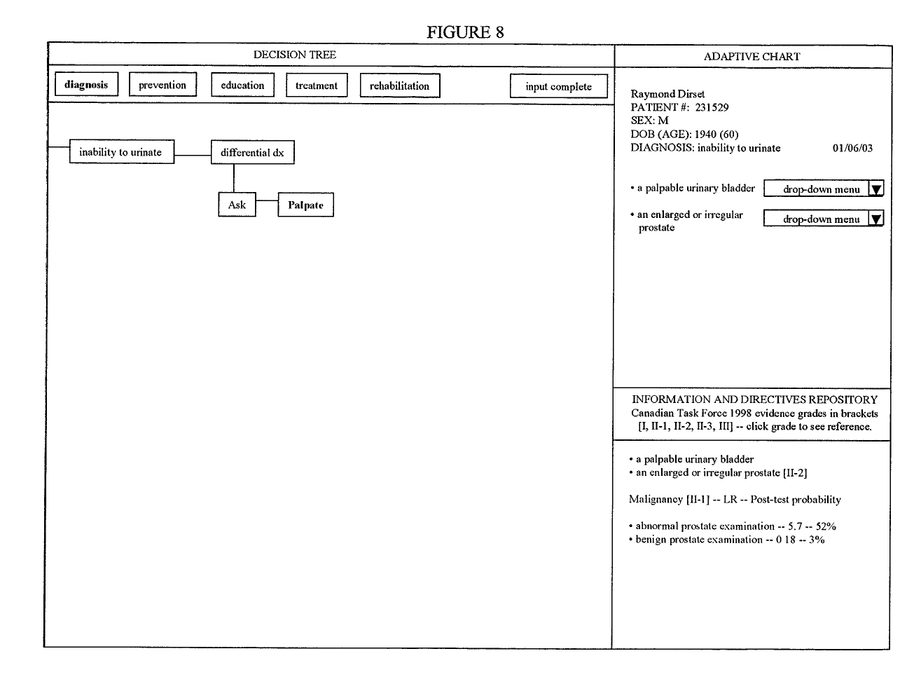

### Step 3 (FIGS. 7 and 8)

After the “Ask” RA data has been gathered, the system may determine that palpation is necessary to continue the differential diagnosis and the tree displays that palpation and entry of the findings into the chart is required. Again, the system prompts the physician to use the chart, to fill in specific information. The user may choose to continue without respecting the Triad's prompt, or may accept the Triad's RA.

The user palpates and enters into the chart whether the patient has an enlarged or irregular prostate or a palpable urinary bladder. Once completed, the user indicates to the system the RA “Palpate” is complete.

System Operations and Displays

Tree.

The tree displays an RA that palpation is suggested.

Chart.

As a result of the tree's decision point, the chart displays a data entry form relating to palpation and accepts data from the user about the palpation.

Repository.

As a result of the tree's decision point and the chart's display of questions relevant to the “Palpation” RA, the repository loads all evidence summaries relevant to the diagnosis of “inability to urinate” for that patient and to the palpation to be performed.

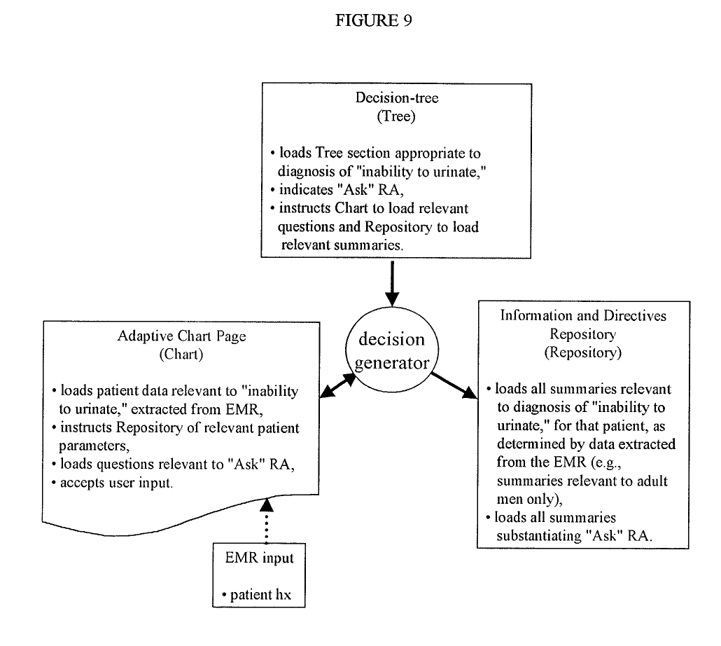

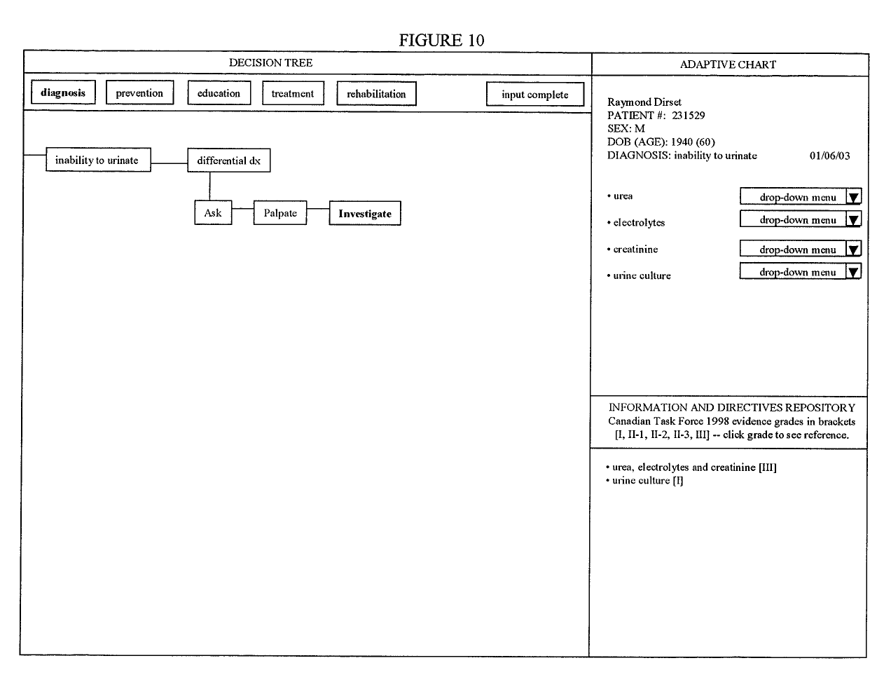

### Step 4 (FIGS. 9 and 10)

As a result of the data gathered at step 3, the system determines a lab investigation is necessary to continue with the differential diagnosis, and the tree indicates that a laboratory investigation is required. Again, the system prompts the physician to use the chart, to fill in specific information. The user may choose to continue without respecting the Triad's prompt, or may accept the Triad's RA. In one embodiment of the system, the laboratory data, as with all patient data, may be already available in the EMR, and the system would automatically upload this data electronically into the chart.

In our example, the user does not need to manually complete the “Investigate” RA, as the data is already available in the patient's EMR. The data is automatically input into the chart, and the system indicates the RA “Investigate” is complete the user may proceed to the next step without further input.

System Operations and Displays

Tree.

The system loads a tree section displaying an “Investigate” RA.

Chart.

As a result of the tree's decision point, the chart displays a data entry form relating to laboratory investigation, and automatically fills in the data from the patient EMR.

Repository.

As a result of the tree's decision point and the chart's display of parameters to be investigated by the laboratory, the repository loads all evidence summaries relevant to the diagnosis of “inability to urinate” for that patient and to the laboratory investigation to be performed.

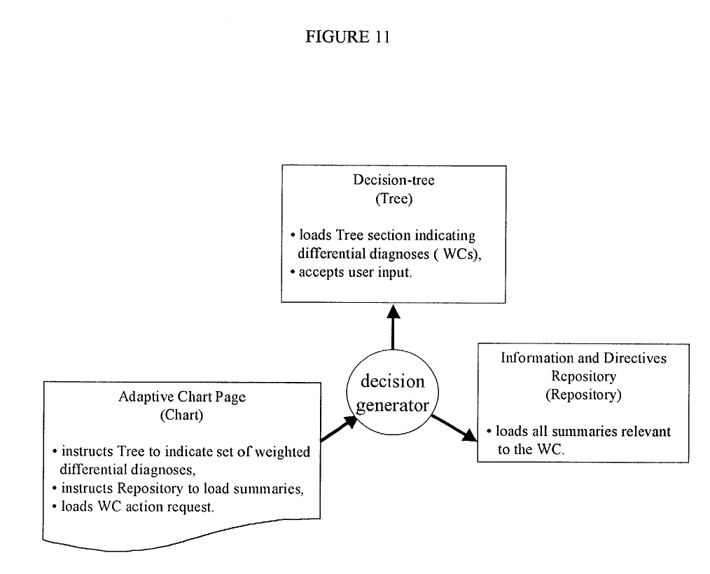

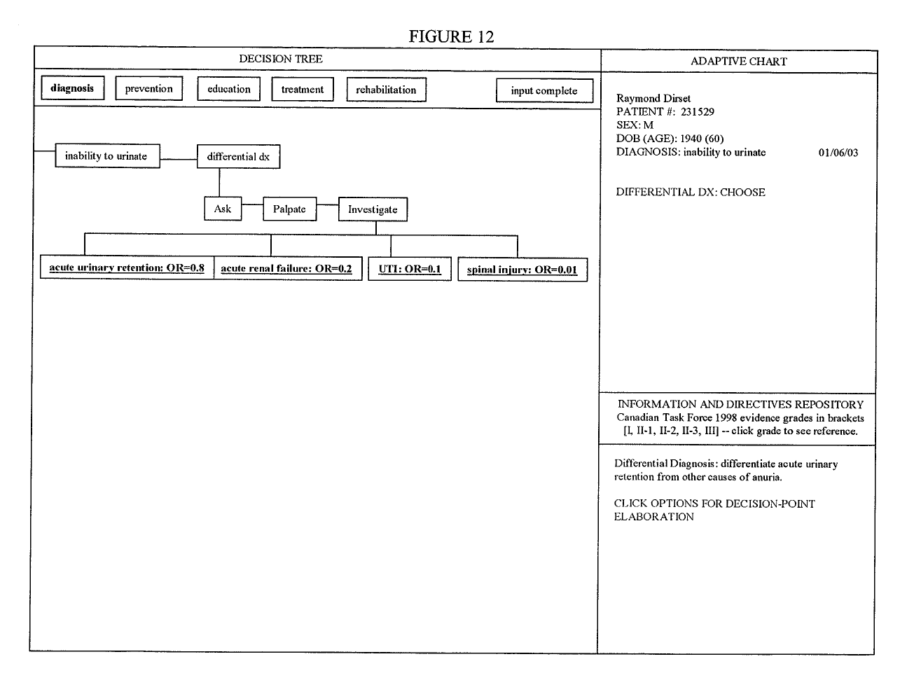

### Step 5 (FIGS. 11 and 12)

As a result of the laboratory investigation data gathered from the patient's EMR, the system determines and displays weighted differential diagnoses requiring a choice between these differential diagnoses. Each is a weighted choice (WC) that includes an odds ratio which indicates the relative probability of that differential diagnosis (i.e., that WC) being the correct one, given the current system data and as computed by the decision generator.

The user accepts the triad's weighting and chooses the most likely differentiating diagnosis (acute urinary retention) and indicates to the system his/her choice is final. Again, the user may choose to continue without respecting the Triad's prompt, or may accept the triad's WC.

System Operations and Displays

Tree.

The system loads and displays a tree section indicating different WCs.

Chart.

As a result of the tree's decision point (a WC in this step), the chart displays a reminder that action may need to be taken on a WC.

Repository.

As a result of the tree's decision point, the repository loads all evidence summaries relevant to the WCs and to the choice between them the user may make.

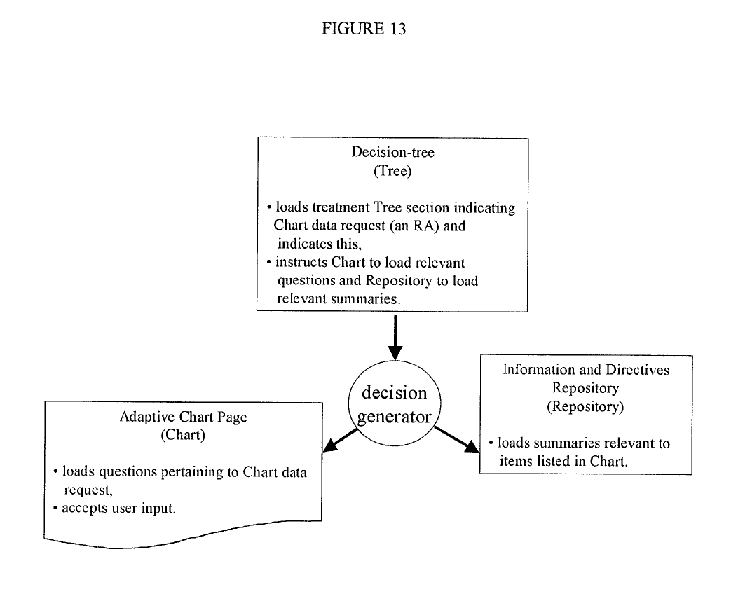

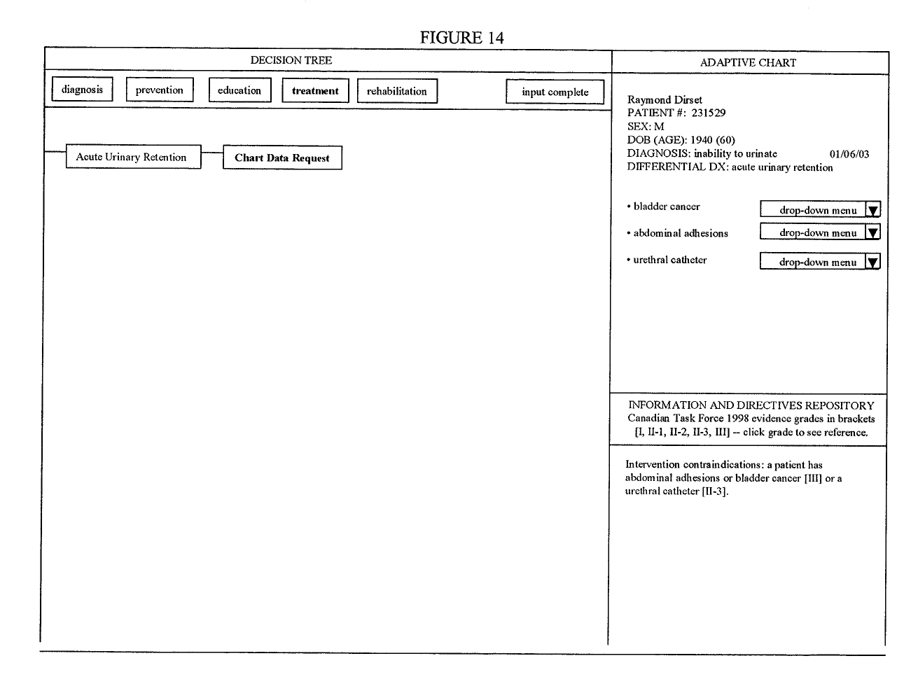

### Step 6 (FIGS. 13 and 14)

As a result of the user's acceptance of acute urinary retention as the differential diagnosis, the triad indicates that diagnosis has proceeded to the point of treatment, and the tree shows a treatment section of this user's decision path.

As a result of the totality of data input and information garnered from summaries and the patient's history, the triad indicates in an RA that further data collection is required to proceed with computing a treatment recommendation.

The triad prompts the user to fill in missing information in the chart. Again, the user may choose to continue without respecting the Triad's prompt, or may accept the triad's RA. The user completes the “chart data request” RA and indicates this to the system.

System Operations and Displays

Tree.

An RA is loaded displaying a chart data request. The tree instructs the chart to load relevant questions and the repository to load relevant summaries.

Chart.

As a result of the tree's displayed RA, the chart loads and displays an entry form pertaining to the required data. The chart accepts user input.

Repository.

As a result of the tree's decision point and the chart's display of required data relevant to the “chart data request” RA, the repository loads all evidence summaries relevant to the diagnosis of “acute urinary retention” for that patient and to these required data.

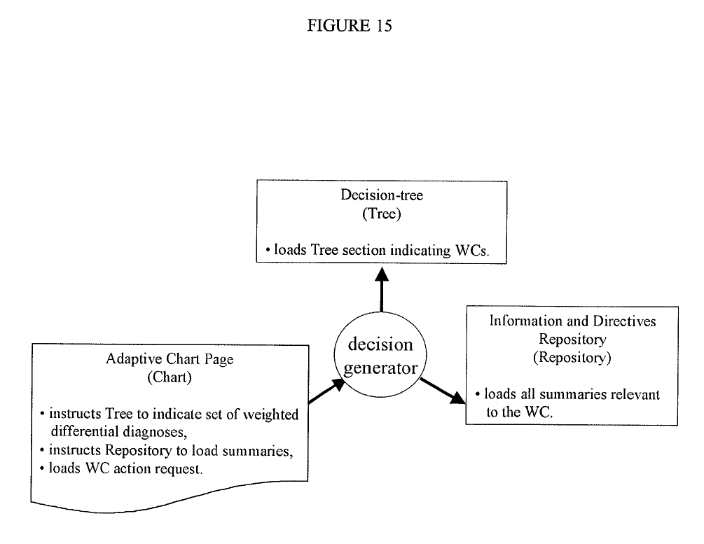

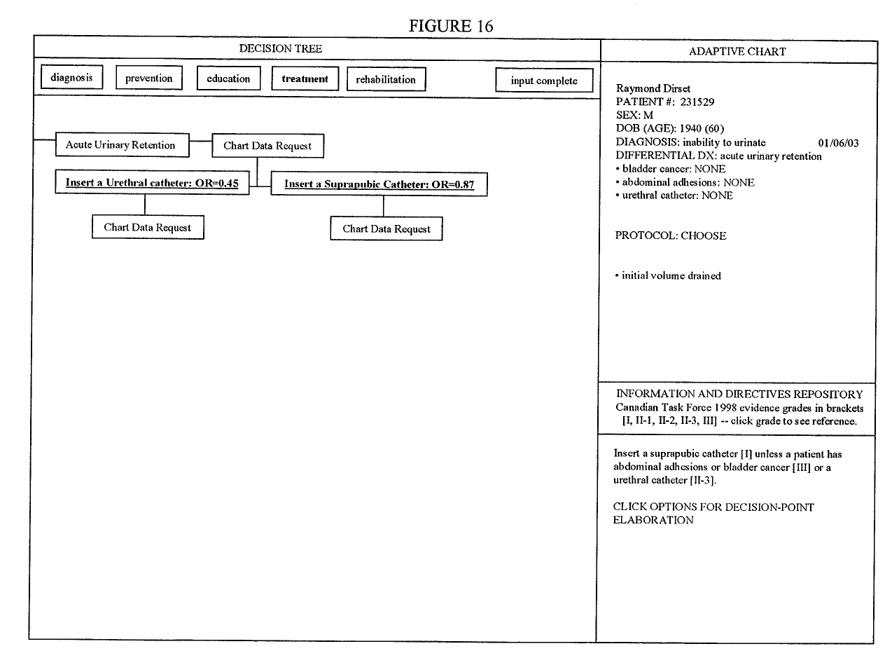

### Step 7 (FIGS. 15 and 16)

Using the additional data entered in step 6, the system determines that a clinical choice between two options is required. The choice between these is a second WC displayed by the tree in our example.

Preferably, the tree may also display an RA intrinsic to the WCs to forewarn the user of action to be taken simultaneously or nearly-simultaneously with executing either WC (e.g., collection of initial urine drained). In our example, the user may be uncertain of the triad's allocation of weights to the WCs, and seeks clarification of the presented WCs relative weights by clicking on one of them.

System Operations and Displays

Tree.

The tree loads and displays the two WCs and their immediate follow-up step—the RA “chart data request.”

Chart.

As a result of the tree's decision point (a WC and a subsequent RA in this step), the chart displays a reminder that action may need to be taken on a WC, and loads and displays an entry form pertaining to the required data. The word “treatment” is now highlighted on the chart.

Repository.

As a result of the tree's WC decision points, the repository loads all evidence summaries relevant to the WCs and to the choice between them the user may make. As well, as a result of the tree's RA decision point and the chart's display of required data relevant to the “chart data request” RA (urine output), the repository loads all evidence summaries relevant to the diagnosis of “acute urinary retention” for that patient and to this required data.

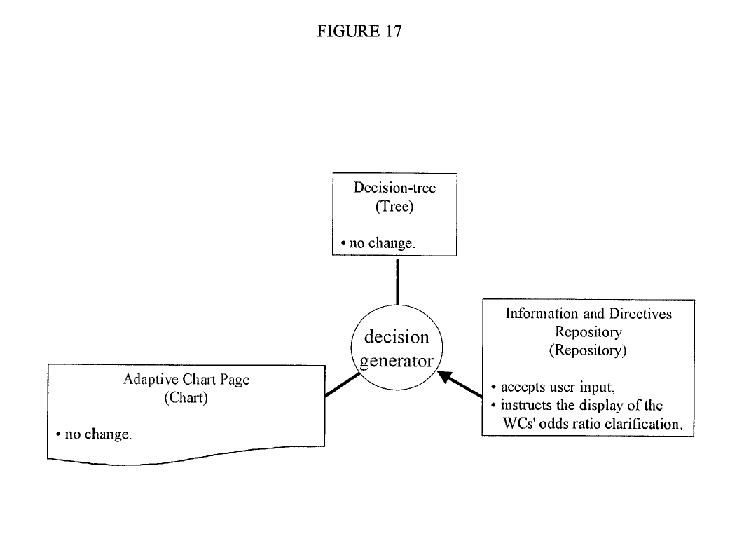

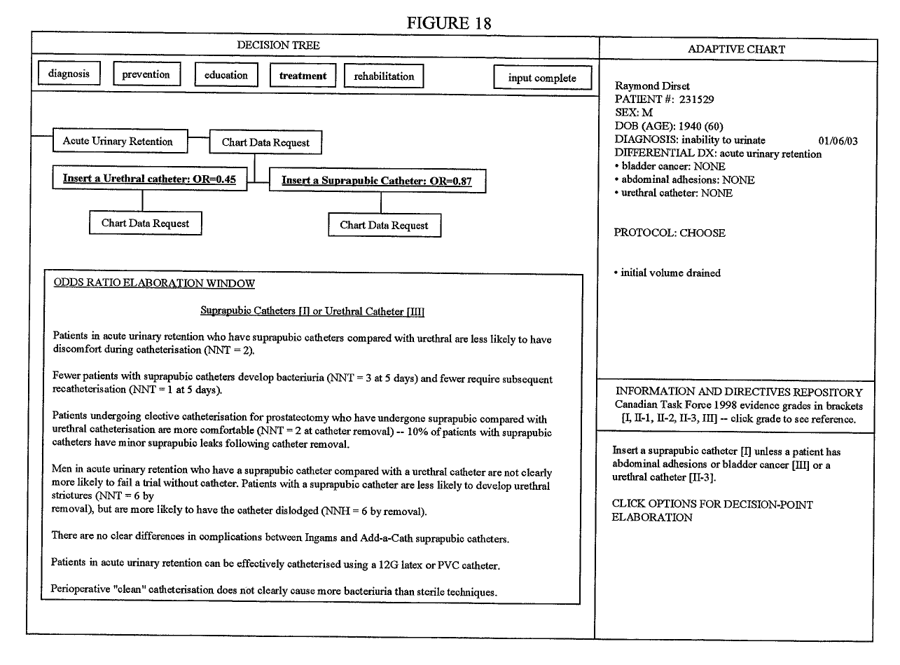

### Step 7a (FIGS. 17 and 18)

The user's request for clarification instructs the system to display the in-depth evidence behind the systems relative allocation of weights to the WCs for this patient.

The user reviews the evidence, and then indicates to the system that the review is complete.

System Operations and Displays

Tree.

There is no change in the tree.

Chart.

There is no change in the chart.

Repository.

As a result of the user's request in step 7, the repository presents an in-depth clarification of the WC weighting in a separate window, ODDS ELABORATION WINDOW. The user may investigate this evidence through hyper-text and other intra-text links to ever greater substantive databases of medical evidence.

### Step 8 (FIG. 16)

Having been instructed that the evidence review is complete, the system returns to its step 7 state, indicating a choice between two WCs should be made. In our example, the user has now reviewed the evidence and accepts the triad's WC weights.

System Operations and Displays

Tree.

There is no change in the tree.

Chart.

There is no change in the chart.

Repository.

The repository again loads all evidence summaries relevant to the tree's WCs and RAs.

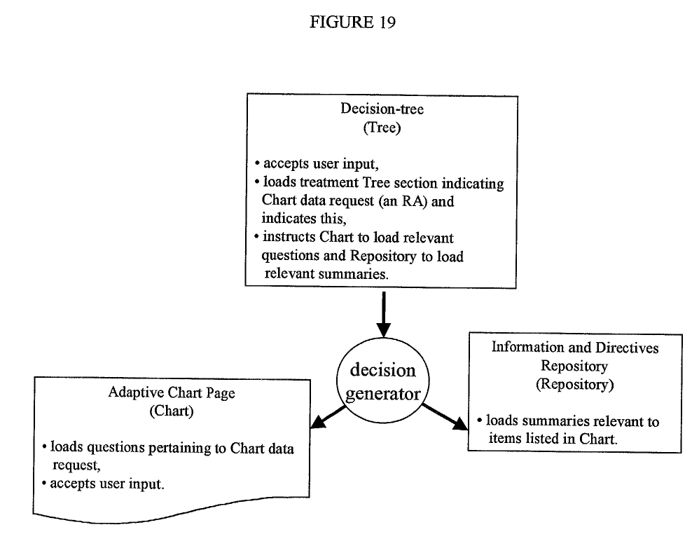

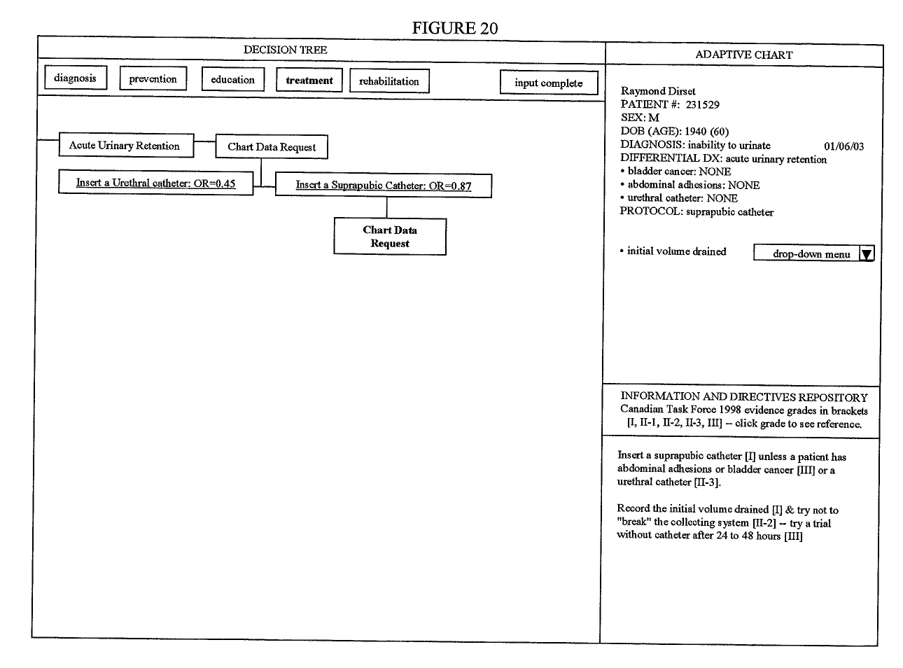

### Step 9 (FIGS. 19 and 20)

The user chooses the option computed to be the most likely treatment—insertion of a suprapubic catheter, noting that the collection and measurement of initial urine drained should follow immediately thereafter. The user indicates to the system the choice is final.

The user completes the insertion of the suprapubic catheter and measures the urine output. The user collects the requested data and enters this into the Chart.

System Operations and Displays

Tree.

There is no change in the tree.

Chart.

There is no change in the chart. The chart accepts user input.

Repository.

There is no change in the repository.

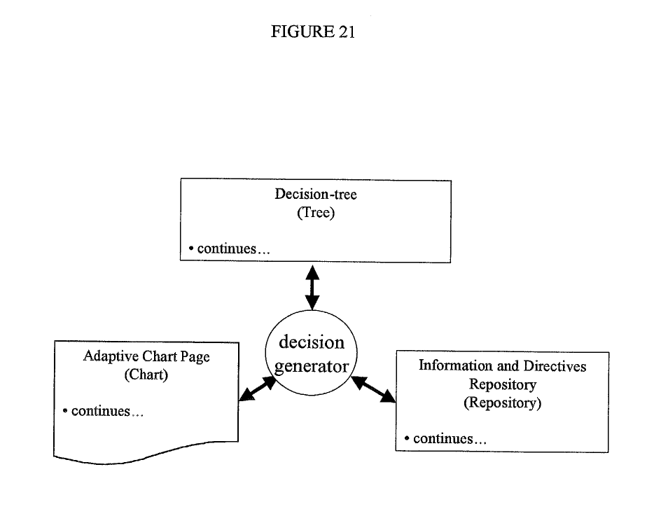

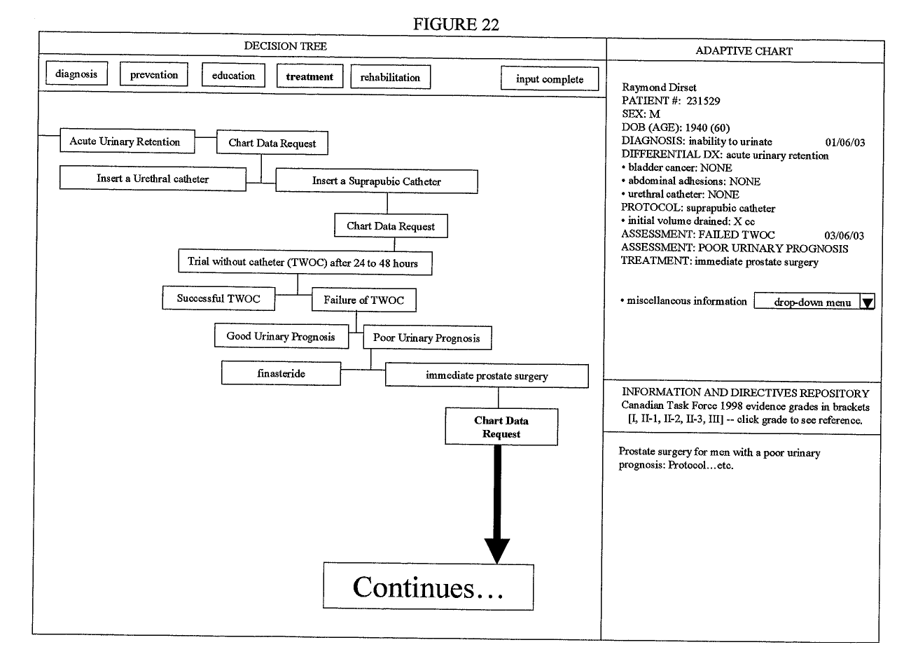

### Step 10 (FIGS. 21 and 22)

The triad accepts the data input into the chart for the purpose of determining the next WC or RA and computing weights where appropriate. The 5-step cycle of data collection, assessment, intervention plan, action and evaluation continues until a final WC is reached and selected, and a new intervention target initiated.

### References

The following references are identified within this application and are incorporated herein by reference.

1. Szolovits P. A Revolution in Electronic Medical Record Systems via the World Wide Web. MIT Laboratory for Computer Science. 2000 (http://wolfgang.hcuge.ch/Library/papers/psz_t.html).

2. Herrick M, Patterson A. Healthcare Trends—The Big Picture Megatrends You Need to Know. Journal of AHIMA. 2000 (http://AHIMA.org/journal/features/feature.0005.1.html).

3. Eglington T. Barriers to Implementing Clinical Practice Guidelines & Recommendations for Action to Be Taken by the WHC to Reinforce the Implementation of Clinical Practice Guidelines in Ontario. Women's Health Council of Ontario. 2000 (unpublished). 13-15,20,39-40

I claim:

1. A medical information decision support system comprising a decision triad, the decision triad including an information/directives repository operatively connected to an adaptive chart and to a decision module via a decision generator wherein the decision generator determines options for providing service to a patient based on information from the information/directives repository, the adaptive chart and input from a user.

2. The system as in claim 1 wherein the information/directives repository and adaptive chart are relational databases.

3. The system claimed in claim 1 wherein the decision module displays weighted choices and recommended advisories in response to user input.

4. The system as in claim 3 wherein each weighted choice includes a computed weight of the probability of accuracy of the weighted choice presented, the computed weight determined by the decision generator from current data from the adaptive chart and repository.

5. The system as in claim 4 wherein selection of a weighted choice or recommended advisory by a user displays further weighted choices or recommended advisories determined by the decision generator from current data from the adaptive chart and repository.

6. The system as claimed claim 3 wherein each weighted choice and recommended advisory is linked to references and summaries of relevant information in the repository.

7. The system as claimed in claim 1 wherein the adaptive chart is operatively connected to an electronic medical record (EMR).

8. The system as claimed in claim 1 wherein the adaptive chart is operatively connected to a laboratory for data entry into the adaptive chart.

9. The system as claimed in claim 3 wherein an RA is dynamically linked to the adaptive chart module and user selection of an RA displays a data entry form on the adaptive chart.

10. The system as claimed in claim 1 wherein the repository includes referenced, standardized summaries of medical information including any one of or a combination of policy and position statements, clinical practice guidelines and formulary statements and/or interpretational clinical directives including any one of or a combination of differential diagnosis trees, treatment algorithms, care-maps and management protocols.

11. The system as claimed in claim 10 wherein the adaptive chart displays trends in clinical data based on current and historical patient data and determined by the decision generator.

12. A system for supporting decision-making comprising: a general information database operatively connected to a situation-specific database and a decision tree through a decision generator, the decision generator for determining decision options for presentation to a user through application of general information database rules to situation-specific database rules.

13. A system as in claim 12 wherein the decision generator provides instructions to a tree rendering engine for displaying a limited number of decision options to the user.

14. A system as in claim 12 wherein the decision generator provides instructions to a chart engine to display relevant data from the situation-specific database and for user-entry of data into the situation-specific database.

15. A system as in claim 12 wherein the decision generator provides instructions to a general information database engine to display information relevant to a specific situation from the general information database.

16. An interface for displaying information for assisting a user in a decision-making process comprising a concurrent display of a decision tree, a general information database and a situation-specific database wherein the decision tree display presents options to a user which upon selection of a specific option updates the general information database display and situation-specific database display to display information relevant to the selected option.

17. A method of assisting a user in a decision-making process comprising the steps of concurrently displaying a portion of a decision tree, a general information database and a situation-specific database wherein the decision tree display presents options to a user which upon selection of a specific option updates the general information database display and situation-specific database display to display information relevant to the selected option only.

18. A decision support system as in claim 1 wherein user selection of a decision module option or entry of data into the adaptive chart provides an update of the information displayed in the information/directives repository, the adaptive chart or the decision module.

19. A decision support system as in claim 1 further comprising an uploading module for uploading information to the information/directives repository and wherein the decision generator can access the uploaded information.

20. Computer readable media containing the method of claim 17.
